(19) United States
(12) Patent Application Publication
(10) Pub. No.: US 2006/0056435 A1
(43) Pub. Date: Mar. 16, 2006

(54) Method of offloading iSCSI TCP/IP processing from a host processing unit, and related iSCSI TCP/IP offload engine

(75) Inventors: Giora Biran, Yaakov (IL); Vadim Makhervaks, Austin, TX (US); Tal Sostheim, Kiryat Tivon (IL); Shaul Yifrach, Haifa (IL)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/217,196

(22) Filed: Sep. 1, 2005

(30) Foreign Application Priority Data
Sep. 10, 2004 (EP) 04300591.7

(51) Int. Cl. H04L 12/56

(52) U.S. Cl. 370/412; 370/389

(57) ABSTRACT

A method of offloading, from a host data processing unit (205), iSCSI TCP/IP processing of data streams coming through at least one TCP/IP connection (307₁,307₂,307₃), and a related iSCSI TCP/IP Offload Engine (TOE). The method including: providing a Protocol Data Unit (PDU) header queue (311) adapted to store headers (HDR₁₁, . . . , HDR₃₂) of iSCSI PDUs received through the at least one TCP/IP connection; monitoring the at least one TCP/IP connection for an incoming iSCSI PDU to be processed; when at least a iSCSI PDU header is received through the at least one TCP/IP connection, extracting the iSCSI PDU header from the received PDU, and placing the extracted iSCSI PDU header into the PDU header queue; looking at the PDU header queue for ascertaining the presence of iSCSI PDUs to be processed, and processing the incoming iSCSI PDU based on information in the extracted iSCSU PDU header retrieved from the PDU header queue.

### TECHNICAL FIELD

The present invention relates generally to the field of data processing systems networks, or computer networks, and particularly to the aspects concerning the transfer of storage data over computer networks, in particular networks relying on protocols like the TCP/IP protocol (Transmission Control Protocol/Internet Protocol).

### BACKGROUND ART

In the past years, data processing systems networks (hereinafter simply referred to as computer networks) and, particularly, those networks of computers that rely on the TCP/IP protocol, have become very popular.

One of the best examples of computer network based on the TCP/IP protocol is the Ethernet, which, thanks to its simplicity and reduced implementation costs, has become the most popular networking scheme for, e.g., LANs (Local Area Networks), particularly in SOHO (Small Office/Home Office) environments.

The data transfer speed of computer networks, and particularly of Ethernet links, has rapidly increased in the years, passing from rates of 10 Mbps (Mbits per second) to 10 Gbps.

The availability of network links featuring high data transfer rates is particularly important for the transfer of data among data storage devices over the network.

In this context, the so-called iSCSI, an acronym which stands for internet SCSI (Small Computer System Interface) has emerged as a new protocol used for efficiently transferring data between different data storage devices over TCP/IP networks, and particularly the Ethernet. In very general terms, iSCSI is an end-to-end protocol that is used to transfer storage data between so-called SCSI data transfer initiators (i.e., SCSI devices that start an Input/Output—I/O—process, e.g., application servers, or simply users's Personal Computers—PCs—or workstations) to SCSI targets (i.e., SCSI devices that respond to the requests of performing I/O processes, e.g., storage devices), wherein both the SCSI initiators and the SCSI targets are connnected to a TCP/IP network. iSCSI has been built relying on two per-se widely used protocols: from one hand, the SCSI protocol, which is derived from the world of computer storage devices (e.g., hard disks), and, from the other hand, the TCP/IP protocol, widely diffused in the realm of computer networks, for example the Internet and the Ethernet.

Without entering into excessive details, known per-se, the iSCSI protocol is a SCSI transport protocol that uses a message semantic for mapping the block-oriented storage data SCSI protocol onto the TCP/IP protocol, which takes the form of a byte stream, whereby SCSI commands can be transported over the TCP/IP network: the generic SCSI Command Descriptor Block (CDB) is encapsulated into an iSCSI data unit, called Packet or Protocol Data Unit (PDU), which is then sent to the TCP layer for being transmitted over the network to the intended destination SCSI target (and, similarly, a response from the SCSI target is encapsulated into an iSCSI PDU and forwarded to the TCP layer for being transmitted over the network to the originating SCSI initiator).

The fast increase in network data transfer speeds, that have outperformed the processing capabilities of most of the data processors (Central Processing Units—CPUs—or microprocessors), has however started posing some problems.

The processing of the iSCSI/TCP/IP protocol aspects is usually accomplished by software applications, running on the central processors (CPUs) or microprocessors of the PCs, workstations, server machines, or storage devices connected to the network. This is not a negligible task for the host central processors: for example, a 1 Gbps network link, rather common nowadays, may constitute a significant burden to a 2 GHz central processor of, e.g., an application server of the network: the server's CPUs may in fact spend half of its processing power to perform relatively low-level processing of TCP/IP protocol-related aspects of the data travelling over the network, with a consequent reduction in the processing power left available to the other running software applications.

In other words, despite the impressive growth in computer networks' data transfer speeds, the relatively heavy processing overhead required by the adoption of the iSCSI/TCP/IP protocol constitutes one of the major bottlenecks against efficient data transfer and against a further increase in data transfer rate over computer networks. This means that, nowadays, the major obstacle against increasing the network data transfer rate is not the computer network transfer speed, but rather the fact that the iSCSI/TCP/IP protocol stack is processed (by the CPUs of the network SCSI devices exchanging the storage data through the computer network) at a rate less than the network speed. In a high-speed network it may happen that a CPU of a SCSI device has to dedicate more processing resources to the management of the network traffic (e.g., for reassembling data packets received out-of-order) than to the execution of the software application(s) it is running.

Solutions for at least partially reducing the burden of processing the low-level TCP/IP protocol aspects of the network traffic on central processors of application servers, file servers, PCs, workstations, storage devices have been proposed. Some of the known devices are also referred to as TCP/IP Offload Engines (TOEs).

Basically, a TOE offloads the processing of the TCP/IP protocol-related aspects from the host processor to a distinct hardware, typically embedded in the Network Interface adapter Card (NIC) of, e.g., the PC or workstation, by means of which connection to the computer network is accomplished.

A TOE can be implemented in different ways, both as a discrete, processor-based component with a dedicated firmware, or as an ASIC-based component, or as a mix of the previous two solutions.

By offloading TCP/IP protocol processing, the host CPU is at least partially relieved from the computing intensive protocol stacks, and can concentrate more of its processing resources on the running applications.

However, since the TCP/IP protocol stack was originally defined and developed for software implementation, the implementation of the processing thereof in hardware poses non-negligible problems, such as how to achieve effective improvement in performance and avoid additional, new bottlenecks in a scaled-up implementation, and how to design an interface to the Upper Layer Protocols (ULPs).

The adoption of the iSCSI protocol introduces further processing burden onto the host CPU of networked SCSI devices. As mentioned before, the iSCSI data units, the so-called PDUs, include each a PDU header portion and, optionally (depending on the PDU type), a PDU payload portion. iSCSI also has a mechanism for improving protection of data against corruption with respect to the basic data protection allowed by the TCP/IP protocol: in particular, the TCP/IP protocol exploits a simple checksum to protect TCP data segment; in order to implement data integrity validation, the iSCSI protocol allows exploiting up to two digests or CRCs (Cyclic Redundant Codes) per PDU: a first CRC may be provided in a PDU for protecting the PDU header, whereas a second CRC may be provided for protecting the PDU payload (when present).

The processing by the host CPU of incoming (inbound) iSCSI PDUs is a heavy task, because it is for example necessary to handle the iSCSI PDUs arriving from possibly multiple TCP/IP connections (with an inherent overhead in terms of interrupt handling by the host CPU), to ensure data intregrity validation by performing CRC calculations, to copy the incoming data into the destination SCSI buffers.

Thus, offloading from a host CPU only the processing of the TCP/IP protocol-related aspects, as the known TOEs do, may be not sufficient to achieve the goal of significantly reducing the processing resources that the host CPU has to devote to the handling of data traffic over the network: some of the aspects peculiar of the iSCSI protocol may still cause a significant burden on the host CPU.

### SUMMARY OF THE INVENTION

In view of the state of the art outlined in the foregoing, the Applicant has tackled the problem of how to reduce the burden on a data processing unit of, e.g., a host PC, workstation, or a server machine of a computer network of managing the low-level, iSCSI/TCP/IP protocol-related aspects of data transfer over the network.

In particular, the Applicant has faced the problem of improving the currently known TOEs, by providing a TOE that at least partially offloads the tasks of processing the iSCSI/TCP/IP-related aspects of data transfer over computer networks.

According to an aspect of the present invention, a method as set forth herein is proposed, for offloading from a host data processing unit iSCSI TCP/IP processing of data streams coming through at least one TCP/IP connection.

The method comprises:

providing a Protocol Data Unit (PDU) header queue adapted to store headers of iSCSI PDUs received through the at least one TCP/IP connection;

monitoring the at least one TCP/IP connection for an incoming iSCSI PDU to be processed;

when at least a iSCSI PDU header is received through the at least one TCP/IP connection, extracting the iSCSI PDU header from the received PDU, and placing the extracted iSCSI PDU header into the PDU header queue;

looking at the PDU header queue for ascertaining the presence of iSCSI PDUs to be processed, and processing the incoming iSCSI PDU based on information in the extracted iSCSU PDU header retrieved from the PDU header queue.

Another aspect of the present invention relates to an iSCSI TCP/IP offload engine as set forth herein, for offloading, from a host data processing unit, iSCSI TCP/IP processing of data streams coming through at least one TCP/IP connection, the offload engine comprising:

an incoming iSCSI PDU monitor adapted to monitor incoming PDUs from at least one TCP/IP connection;

a PDU header queue common for all the TCP/IP connections;

a PDU header extractor adapted to extract a PDU header from an incoming PDU, placing the extracted header into the header queue, and managing a signalling of the presence in the PDU header queue of a PDU header to be processed to a PDU header processor.

Thanks to the method according to the above-mentioned aspect of the present invention, and to the related TCP/IP offload engine, the host processing unit of a SCSI device of the network is at least partially relieved from the computing-intensive handling of the iSCSI/TCP/IP protocol stack.

### BRIEF DESCRIPTION OF THE DRAWINGS

The features and advantages of the present invention will be made apparent by the following detailed description of an embodiment thereof, provided merely by way of a non-limitative example, description that will be conducted making reference to the attached drawings, wherein:

FIG. 1 is a schematic view of an exemplary computer network, particularly a TCP/IP-based network and, even more particularly, an Ethernet network;

FIG. 2 schematically shows the main functional blocks of a generic computer of the computer network of FIG. 1, such as, for example, a user's PC or workstation, or a server computer (e.g., an application server);

FIG. 3 schematically shows the main functional blocks of a TCP/IP Offload Engine (TOE) according to an embodiment of the present invention;

FIG. 4 depicts schematically the structure of a generic iSCSI Protocol Data Unit (PDU);

FIG. 5 shows very schematically the structure of an iSCSI assistant unit of the TOE of FIG. 3, in one embodiment of the present invention;

FIG. 6, consisting of 6A, 6B, 6C and 6D, is a very simplified flowchart illustrating the operation of the iSCSI assistant of FIG. 5, in one embodiment of the present invention.

### DETAILED DESCRIPTION OF THE PREFERRED EMBODIMENT

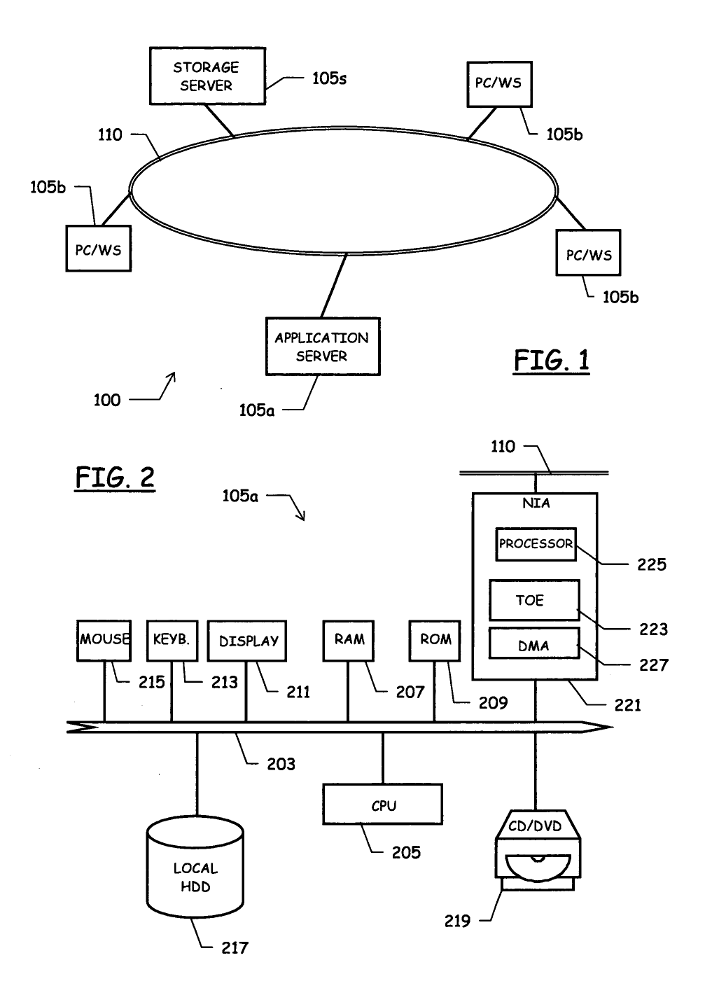

With reference to the drawings, and particularly to FIG. 1, an exemplary computer network 100 is schematically shown. The computer network 100 may for example be the LAN of an enterprise, a bank, a public administration, a SOHO environment or the like, the specific type of network and its destination being not a limitation for the present invention.

The computer network 100 comprises a plurality of network components 105a, 105b, 105c, . . . , 105n, for example Personal Computers (PCs), workstations, machines used as file servers, and/or application servers, printers, mass-storage devices and the like, networked together, by means of a communication medium schematically depicted in FIG. 1 and denoted therein by reference numeral 110.

The computer network 100 is in particular a TCP/IP-based network, i.e. a network relying on the TCP/IP protocol for communications, and is for example an Ethernet network, which is by far the most popular architecture adopted for LANs. In particular, and merely by way of example, the computer network 100 may be a 1 Gbps or a 10 Gbps Ethernet network. The network communication medium 110 may be a wire link or an infrared link or a radio link.

However, although in the description which will be conducted hereinafter reference will be made by way of example to an Ethernet network, it is intended that the present invention is not limited to any specific computer network configuration, being applicable to any computer network over which, for the transfer of storage data between different network components, the iSCSI protocol is exploited.

In the following, merely by way of example, it will be assumed that the computer network 100 includes, among its components, an application server computer, in the shown example represented by the network component 105a, i.e. a computer, in the computer network 100, running one or more application programs of interest for the users of the computer network, such users being connected to the network 100 and exploiting the services offered by the application server 105a by means of respective user's Personal Computers (PCs) and/or workstations 105b. It will also be assumed that the computer network 100 includes a storage device, for example a storage server or file server, in the shown example represented by the network component 105s. Other components of the network 100 may include for example a Network Array Storage (NAS).

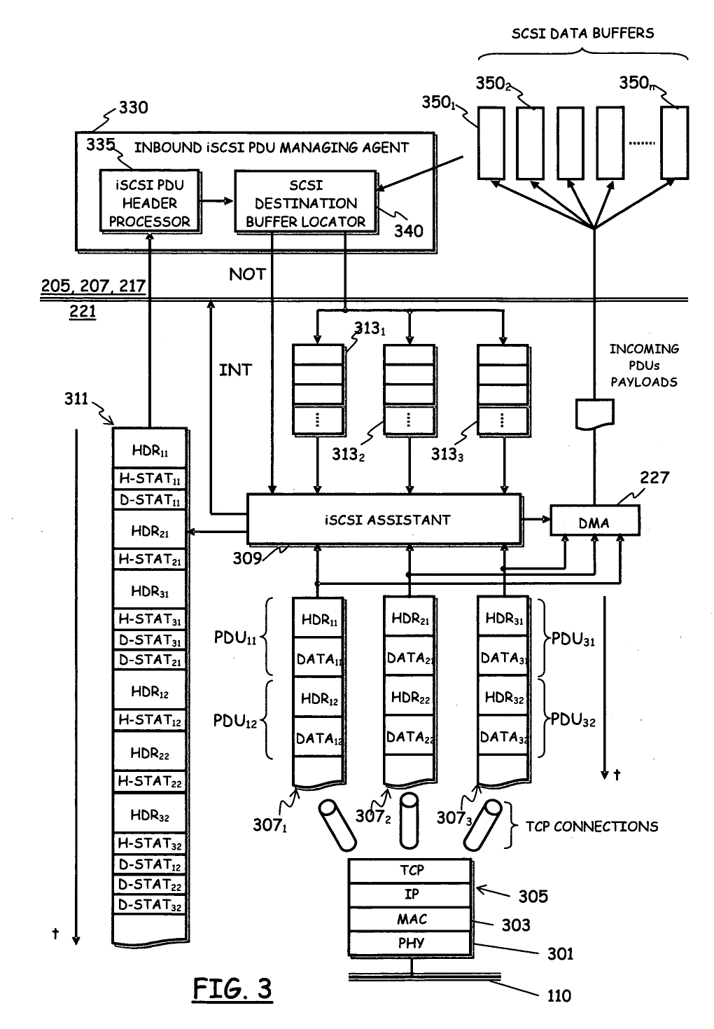

As schematically shown in FIG. 2, a generic computer of the network 100, for example the application server computer 105a, comprises several functional units connected in parallel to a data communication bus 203, for example a PCI bus. In particular, a Central Processing Unit (CPU) 205, typically comprising a microprocessor, e.g. a RISC processor (possibly, the CPU may be made up of several distinct and cooperating CPUs), controls the operation of the application server computer 105a; a working memory 207, typically a RAM (Random Access Memory) is directly exploited by the CPU 205 for the execution of programs and for temporary storage of data, and a Read Only Memory (ROM) 209 stores a basic program for the bootstrap of the production server computer 105a. The application server computer 105a may (and normally does) comprise several peripheral units, connected to the bus 203 by means of respective interfaces. Particularly, peripheral units that allow the interaction with a human user may be provided, such as a display device 211 (for example a CRT, an LCD or a plasma monitor), a keyboard 213 and a pointing device 215 (for example a mouse or a touchpad). The application server computer 105a also includes peripheral units for local mass-storage of programs (operating system, application programs, operating system libraries, user libraries) and data, such as one or more magnetic Hard-Disk Drivers (HDD), globally indicated as 217, driving magnetic hard disks, and a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards, a magnetic tape mass-storage storage unit and the like.

The application server computer 105a is further equipped with a Network Interface Adapter (NIA) card 221 for the connection to the computer network 100 and particularly for accessing, at the very physical level, the communication medium 110. The NIA card 221 is a hardware peripheral having its own data processing capabilities, schematically depicted in the drawings by means of an embedded processor 225, that can for example include a microprocessor, a RAM and a ROM, in communication with the functional units of the computer 105a, particularly with the CPU 205. The NIA card 221 preferably includes a DMA engine 227, adapted to handle direct accesses to the storage areas of the computer 105a, such as for example the RAM and the local hard disks, for reading/writing data therefrom/thereinto, without the intervention of the CPU 205.

According to an embodiment of the present invention, a TCP/IP Offload Engine (TOE) 223 is incorporated in the NIA card 221, for at least partially offloading from the CPU 205 (the host CPU) of the application server 105a the heavy processing of the TCP/IP-related aspects of the data traffic exchanged between the application server 105a and, e.g., the storage server 105s or the user's PCs 105b.

In particular, in an embodiment of the present invention, the TOE 223 is adapted to enable the NIA card 221 performing substantial amount of protocol processing up to the iSCSI layer, as will be described in greater detail later in this description.

Any other computer of the network 100, in particular the storage server 105s, has the general structure depicted in FIG. 2, particularly in respect of the NIA 221 with the TOE 223. It is however pointed out that the present invention is not limited to the fact that either one of or both the network components exchanging storage data according to the iSCSI protocol are computers having the structure depicted in FIG. 2: the specific structure of the iSCSI devices is not limitative to the present invention.

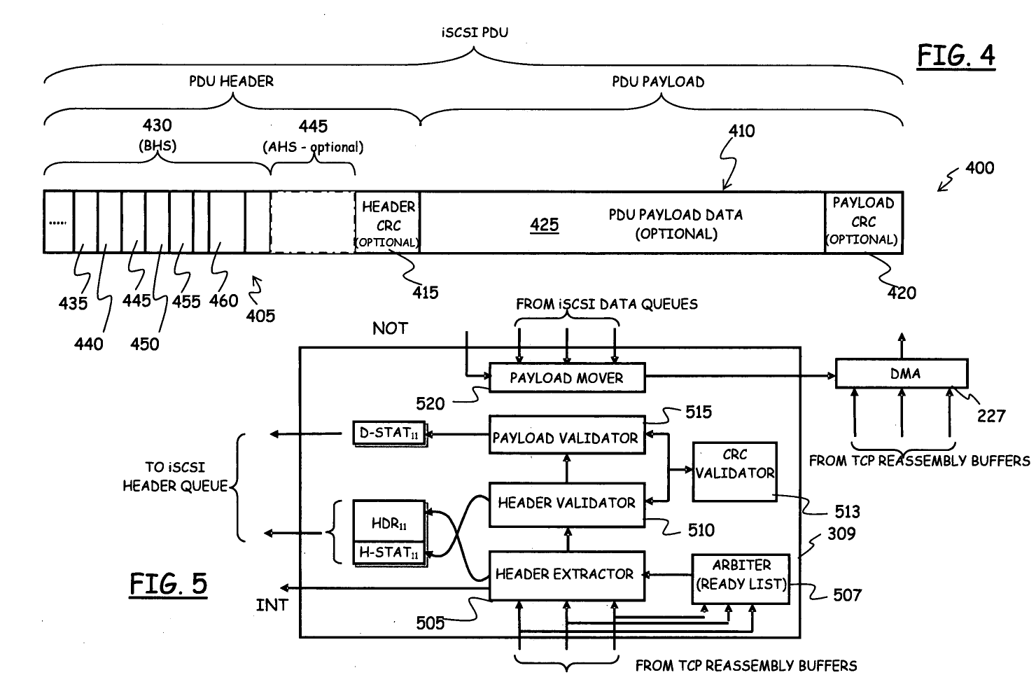

FIG. 3 is a schematic representation, in terms of functional blocks relevant to the understanding of the exemplary invention embodiment herein described, of the internal structure of the NIA card 221 with the TOE 223 included therein.

The NIA card 221 includes physical-level interface devices 301, implementing the PHYsical (PHY) layer of the Open Systems Interconnect (OSI) “layers stack” model set forth by the International Organization for Standardization (ISO). The PHY layer 301 handles the basic, physical details of the communication through the network communication medium 110. Above the PHY layer 301, Media Access Control (MAC) layer interface devices 303 implement the MAC layer, which, among other functions, is responsible for controlling the access to the network communication medium 110.

The TOE 223 embedded in the NIA 221 includes devices 305 adapted to perform TCP/IP processing of the TCP/IP data packets, particularly the TCP/IP data packets received from one or more TCP connections through the network communication medium 110.

A TCP/IP data packet is a packet of data complying, at the network layer protocol (the ISO-OSI layer directly above the MAC layer), with the IP protocol (the network layer protocol of the Internet), and also having, as the transport layer protocol, the TCP protocol.

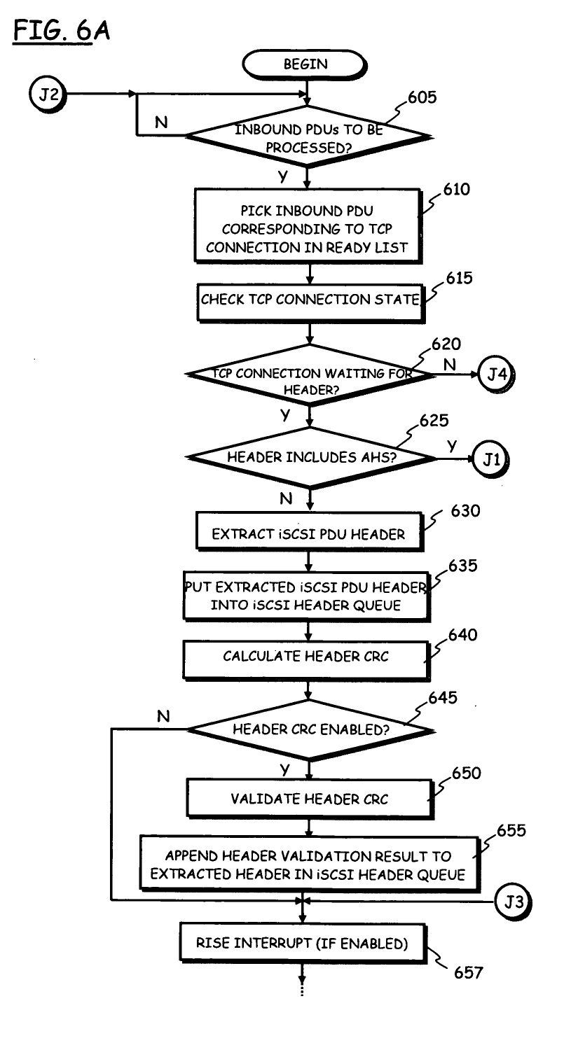

According to the iSCSI protocol, the conventional SCSI protocol is mapped onto the TCP byte stream using a peculiar message semantic. Data to be transferred over the network are formatted in Packet Data Units or Protocol Data Units (PDUs); in FIG. 4, the structure of a generic iSCSI PDU 400 is represented very schematically. Generally speaking, every PDU 400 includes a PDU header portion 405 and, optionally a PDU payload portion 410 (the presence of the PDU payload portion depends on the type of PDU: some iSCSI PDUs do not carry data, and comprise only the header portion 405).

The PDU 400 may include two data integrity protection fields, namely two data digests or CRC (Cyclic Redundant Code) fields 415 and 420: a first CRC field 415 (typically, four Bytes) can be provided for protecting the information content of the PDU header 405 portion, whereas the second CRC field 420 can be provided for protecting the information content of the PDU payload portion 425 (when present). It is pointed out that both the two CRC fields 415 and 420 are optional; in particular, the second CRC field 420 is absent in those PDUs that do not carry a payload. The possibility of having up to two CRC fields implements the iSCSI mechanism for improving protection of data against corruption with respect to the basic data protection allowed by the TCP/IP protocol: the TCP/IP protocol exploits a simple checksum to protect TCP data segments; in order to implement data integrity validation, the iSCSI protocol allows exploitings up to two CRCS per PDU: a first CRC protecting the PDU header, and a second CRC protecting the PDU payload. It is observed that either the header CRC 415, or the payload CRC 420, or both may be selectively enabled or disabled; in particular, the payload CRC 420 will be disabled in case the PDU lacks the payload portion 410.

The PDU 400 starts with a Basic Header Segment (BHS) 430; the BHS 430 has a fixed and constant size, particularly it is, currently, 48 Bytes long. Despite its fixed and constant length, the structure of the BHS 430 varies depending on whether the iSCSI PDU 400 is a command PDU or a response PDU. A command PDU is a PDU that is issued by an iSCSI initiator, and carries commands, data, status information for an iSCSI target; conversely, a response PDU is a PDU that is issued by an iSCSI target in reply to a command PDU received from an iSCSI initiator. The BHS 430 contains information adapted to completely describe the length of the whole PDU 400; in particular, among other fields, the BHS 430 includes a field 435 (TotalPayloadLength) wherein information specifying the total length of the PDU payload 410 are contained, and a field 440 (AHSlength) wherein information specifying the length of an optional, Additional Header Segment (AHS) 445 are contained. The AHS 445 is (as the name suggest) an optional, additional portion of the PDU header 405, that, if present (a situation identified by the fact that the field 440 contains a value different from zero) follows the BHS 430, and allows expanding the iSCSI PDU header 405 so as to include additional information over those provided by the BHS 430.

Still depending on the type of PDU, the BHS 430 may further include fields 445, 450, 455, 460 carrying the Initiator Task Tag (ITT), an identifier of the SCSI task, the Target Transfer Tag (TTT—a tag assigned to each “Ready To Transfer” request sent to the initiator by the target in reply to a write request issued by the initiator to the target), a Logical Unit Number (LUN), a SCSI Command Descriptor Block (CBD).

As mentioned in the introductory part of the present description, processing in software, e.g. by the CPU 205 of the server 105a (the host CPU), of the iSCSI/TCP/IP protocol-related aspects of the data stream is heavy, in terms of required processing power.

In particular, the processing in software of incoming (inbound) iSCSI PDUs, by, e.g., the server, host CPU 205 is a heavy task, particularly because the host CPU 205 has normally to handle the iSCSI PDUs arriving from multiple TCP/IP connections (with an inherent overhead in terms of interrupts), ensure data intregrity validation by performing CRC calculations (when one or both of the CRCs are present in the PDU), copy the incoming data into the proper destination SCSI data buffers. A generic iSCSI session between an initiator and a target may in fact be composed of more than one TCP/IP connections, over which the communication between an iSCSI initiator, for example the application server 105a, and an iSCSI target, in the example the storage server 105s, takes place. For example, the application server 105a, while running the intended application(s), may need to perform read and/or write operations from/into a storage device, e.g. a local hard disk, held by the storage server 105s: if this happens, the application server 105a starts an iSCSI session, setting up one or more TCP/IP connections with the storage server 105s.

Offloading from the host CPU only the handling of the aspects related to the TCP/IP protocol may be not sufficient to significantly reduce the computing resources that the CPU 205 of, e.g., the server 105a (more generally, the processor of the generic iSCSI device) has to devote to the processing of the storage data traffic exchanged over the network. Some of the aspects peculiar of the iSCSI protocol may still cause a significant burden on the CPU 205.

According to an embodiment of the present invention, in the aim of solving such a problem, in addition to offloading the handling the TCP/IP protocol aspects of the incoming data stream, also the processing of incoming iSCSI PDUs is partially offloaded from the host CPU 205, to a peripheral thereof, for example to the NIA 221 (albeit this is not to be intended as a limitation of the present invention, since a distinct CPU's peripheral might be provided for, to which the processing of incoming iSCSI PDUs is offloaded).

Referring back to FIG. 3, reference numerals 307₁, 307₂ and 307₃ denotes a plurality (three in the shown example) of TCP data streams, corresponding to (three) respective different TCP connections. It is observed that, in addition to TCP data streams, the elements identified as 307₁, 307₂ and 307₃ may also be regarded as TCP data stream reassembly buffers, wherein the iSCSI PDUs from the different TCP connections are reassembled, as long as data traffic is received by the lower, TCP/IP layers 305.

According to an embodiment of the present invention, the TCP data streams (i.e., correspondingly, the data reassembled in the reassembly buffers) 307₁, 307₂ and 307₃ are fed to an iSCSI assistant 309, in order to be processed at the TOE 223 level.

In particular, the iSCSI assistant 309 exploits an iSCSI header queue 311, and a plurality (three in the shown example) of iSCSI data queues 313₁, 313₂ and 313₃, particularly one iSCSI data queue for each TCP connection.

As will be described in greater detail in the following, the iSCSI header queue 311 is used by the iSCSI assistant 309 for storing the header portions (shortly, the headers) HDR₁₁, . . . , HDR₃₂ extracted from incoming iSCSI PDUs PDU₁₁, . . . , PDU₃₂, arriving through the different TCP data streams 307₁, 307₂ and 307₃. The iSCSI data queues 313₁, 313₂ and 313₃ are instead used to hold information (e.g., pointers, references, descriptors) adapted to allow the iSCSI assistant 309 identifying individually the proper SCSI data buffers 350₁, 350₂, . . . , 350ₙ among a plurality of such buffers, which are the destination buffers whereinto the iSCSI PDU payload portions DATA₁₁, . . . , DATA₃₂ extracted from the incoming PDUS PDU₁₁, . . . , PDU₃₂ (when the payload portion is present) are copied. In particular, in an embodiment of the present invention, a DMA mechanism, particularly the DMA engine 227 of the NIA 221 is exploited by the iSCSI assistant 309 for directly accessing the proper storage area of, e.g., the application server 105a, wherein the SCSI data buffers 350₁, 350₂, . . . , 350ₙ are located, for example an area of the RAM or of the local hard disk, and for moving the payload portions of the incoming PDUs from the input TCP data stream (i.e., from the reassembly buffers) 307₁, 307₂ and 307₃ to the proper destination SCSI data buffers 350₁, 350₂, . . . , 350ₙ.

It is observed that the iSCSI header queue 311 and/or the iSCSI data queues 313₁, 313₂ and 313₃ may be located in the internal memory of the NIC 221, or they may be located in the system memory of the application server 105a, e.g. in the RAM or on the local hard disk; in this second case, the DMA engine of the NIA 211 may be exploited for writing/retrieving data to/from the iSCSI header queue 311 and/or the iSCSI data queues 313₁, 313₂ and 313₃.

The iSCSI assistant 309 detects the inbound iSCSI PDUs PDU₁₁, . . . , PDU₃₂, arriving through the TCP data streams 307₁, 307₂ and 307₃ (i.e., it detects PDUs in the reassembly buffers 307₁, 307₂ and 307₃); in particular, the iSCSI assistant 309 detects iSCSI PDU boundaries in the arriving TCP data streams. When an inbound iSCSI PDU is detected in a generic one of the reassembly buffers 307₁, 307₂ and 307₃ associated with the different TCP connections, the iSCSI assistant 309 separates the PDU headers HDR₁₁, . . . , HDR₃₂ from the PDU payloads DATA₁₁, . . . , DATA₃₂; the separated headers HDR₁₁, . . . , HDR₃₂ are accumulated into the iSCSI header queue 311, whereas, using the information retrieved from the iSCSI data queues 313₁, 313₂ and 313₃, the iSCSI assistant 309 instructs the DMA engine 227 to directly copy the PDU payloads DATA₁₁, . . . , DATA₃₂ into the proper destination SCSI buffer 350₁, 350₂, . . . , 350ₙ.

In particular, the iSCSI header queue 311 may be implemented as a contiguous cyclic buffer, wherein the headers of the received PDUs are stored (in the order the PDUs are received).

Quite schematically, and in an exemplary embodiment of the present invention, the iSCSI header queue 311 is exploited by an iSCSI PDU header processor 335, part of an inbound PDU managing agent 330, running for example under the control of the host CPU 205 (although this is not to be intended as a limitation to the present invention, because the inbound PDU managing agent 330 might as well be running under the control of the processor 225 of the NIA 221, more generally under the control of the processing unit embedded in the peripheral that implements the TOE 223). The iSCSI PDU header processor 335 provides to an SCSI destination buffer locator 340 information, got from the iSCSI header queue 311, useful for identifying the different SCSI destination buffers 350₁, 350₂, . . . , 350ₙ; using such information, the SCSI destination buffer locator 340 locates the proper destination SCSI buffers, and the location inside the buffer where data have to be copied, and posts to the proper iSCSI data queues 313₁, 313₂ and 313₃ information adapted to allow the iSCSI assistant 309 individually identifying the different SCSI destination buffers 350₁, 350₂, . . . , 350ₙ, where data carried by the inbound PDUs have to be copied. It is pointed out that the separation of the inbound PDU managing agent 330 into an iSCSI PDU header processor 335 and a SCSI destination buffer locator 340 is merely exemplary, and not limitative: alternative embodiments are possible.

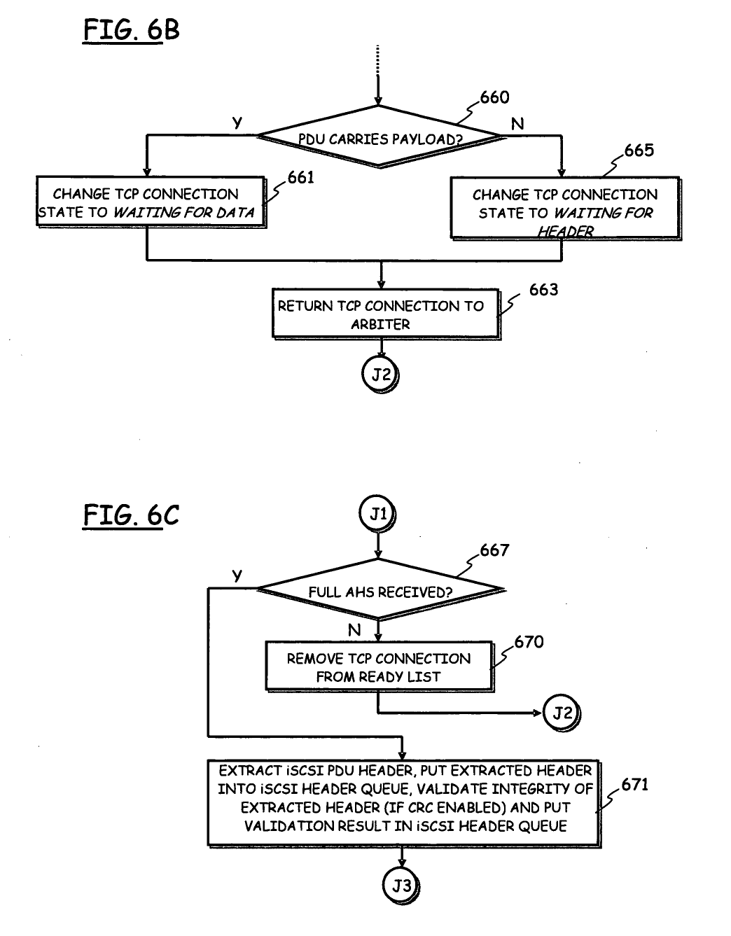

In FIG. 5 the iSCSI assist 309 is shown again quite schematically, but in slightly greater detail. The iSCSI assistant 309 comprises a PDU header extractor 505 that extracts a full header 405 from the generic inbound PDU 400, coming over the generic TCP data stream 307₁, 307₂ and 307₃. The header extractor 505 operates under control of an arbiter 507, that keeps a list of those TCP connections that have received an amount of data sufficient to be processed; the header extractor 505 places the extracted header 405 into the iSCSI header queue 311. While the inbound PDU is processed by the header extrtactor 505, a header validator 510 validates “on the fly” the header CRC (when it is present in the incoming PDU); in particular, invoking a CRC validator 513, the CRC of the PDU header is calculated on the fly, and the calculated CRC is compared to the header CRC 415, in order to validate the integraity of the received iSCSI header; the result of the validation is appended to the extracted PDU header 405 as a header status (like H-STAT₁₁, H-STAT₂₁, etc. in FIG. 3) and placed into the iSCSI header queue 311. It is observed that the header validator 510 only validates the CRC of the header if the header CRC is enabled, for the TCP connection under consideration.

The iSCSI assistant 309 further includes a payload validator 515, that validates the data integrity of the PDU payload, by calculating (using for example the services of the CRC validator 513) on the fly the CRC of the PDU payload 410. The result of the payload validation is placed into the iSCSI header queue 311 as a data status (like D-STAT₁₁, D-STAT₂₁, etc. in FIG. 3); it is observed that, while the generic extracted PDU header in the iSCSI header queue 311 is immediately followed by the respective header status (when the header CRC is enabled), this is not the case for the data status, because the latter is calculated and placed into the iSCSI header queue 311 only after the data movement is completed. It is also observed that also in this case, the payload validator 515 only validates the CRC of the header if the payload CRC is present, i.e. if the incomong PDU carries a payload, and the payload CRC is enabled, for the TCP connection under consideration.

The iSCSI assistant 309 further includes a PDU payload mover 520 that interacts with the iSCSI data queues 313₁, 313₂ and 313₃ and with the DMA engine 227 for causing the latter to move the payload 410 of the inbound PDUs to the proper SCSI buffer 350₁, 350₂, . . . , 350ₙ, according to the SCSI data buffer identifying and description information retrieved from the iSCSI data queues 313₁, 313₂ and 313₃.

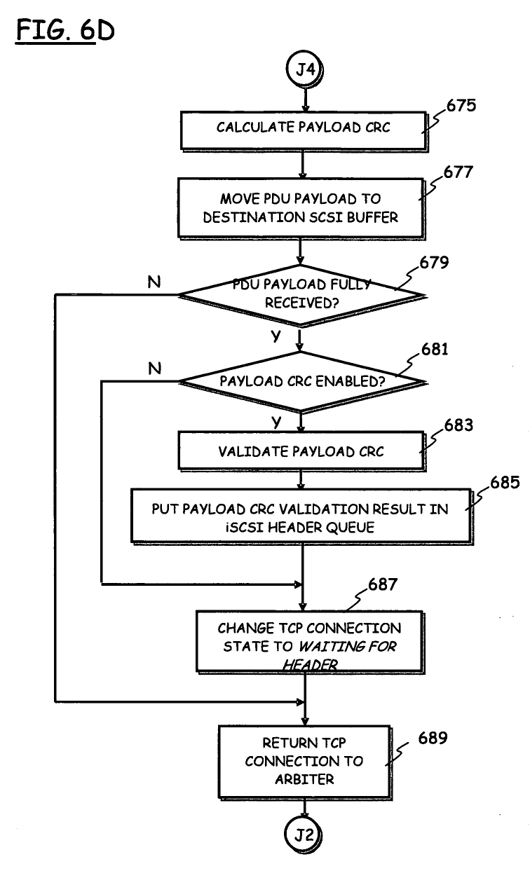

The operation of the iSCSI assist 309 according to an embodiment of the present invention will be hereinafter described, making reference to the simplified, schematic flowchart of FIG. 6.

It is assumed that an iSCSI session has been set up, following a usual login process, between the application server 105a, assumed to be the iSCSI initiator, and the file server 105s, assumed to be the iSCSI target (however, it is pointed out that this is not to be construed as limitative for the present invention, since the iSCSI offoload applies as well to iSCSI initiators and iSCSI targets). Merely by way of example, it is also assumed that a plurality of, e.g., three different TCP connections exist, corresponding to the three TCP data streams (that correspond to respective reassembly buffers, which are managed by the lower, TCP/IP layers) 307₁, 307₂ and 307₃. The plurality of (three, in the example considered) different TCP connections may for example belong to a same iSCSI session, or they may belong different iSCSI sessions (i.e., multiple iSCSI sessions may exist and be active).

The iSCSI assistant 309 constantly looks for inbound PDUs that are ready to be processed (decision block 605). In particular, the arbiter 507 performs an arbitration of the different TCP data streams 307₁, 307₂ and 307₃, depending on the respective TCP connection state: the generic TCP connection 307₁, 307₂ and 307₃ of the generic iSCSI session can in fact be in one of two states, namely a “WAITING FOR HEADER” state or a “WAITING FOR DATA” state.

In case a generic TCP connection 307₁, 307₂ and 307₃ is in the WAITING FOR HEADER state, the arbiter 507, monitoring the reassembly buffer corresponding to that TCP connection, waits until at least a complete BHS 430 is received through that TCP connection, and the received BHS is available in the corresponding reassembly buffer (wherein, as mentioned in the foregoing, the BHS is that part of the PDU header 405 that is always present in a PDU, and has a fixed, constant length, typically of 48 Bytes). When the arbiter 507 detects that at least the full BHS 430 of a PDU has been received through a generic TCP connection, the arbiter considers that TCP connection as ready to be processed, and such a TCP connection is placed into a “TCP connection ready” list, managed by the arbiter 507, waiting to be further processed by the iSCSI assistant 309.

If the generic TCP connection is instead in the WAITING FOR DATA state, the arbiter 507 adds that TCP connection to the TCP connection ready list only when the arbiter 507, monitoring the reassembly buffer corresponding to that TCP connection, ascertains that a sufficient amount of data (a sufficient data chunk, whose size is preferably user-configurable, for example through a configuration parameter) has been received through that TCP connection, and one of the SCSI destination data buffers 350₁, 350₂, . . . , 350ₙ has been posted (by the SCSI destination buffer locator 340) to the iSCSI data queue 313₁, 313₂ and 313₃ corresponding to that TCP connection (the fact that a SCSI data buffer 350₁, 350₂, . . . , 350ₙ has been posted to the proper iSCSI data queue 313₁, 313₂ and 313₃ means that the application server 105a—in particular, the inbound PDU managing agent 330—is ready to have the incoming PDU payload moved to the proper SCSI destination data buffer 350₁, 350₂, . . . , 350ₙ).

Back to the schematic flowchart of FIG. 6, in block 605 the iSCSI assistant 309 looks at the TCP connection ready list and checks whether there is any one of the TCP connections 307₁, 307₂ and 307₃ which is ready to be processed: in the negative case (exit branch N) the iSCSI assistant 309 keeps on waiting for a TCP connection to be placed into the TCP connection ready list, otherwhise (exit branch Y) it picks one of the TCP connections 307₁, 307₂ and 307₃ from the TCP connection ready list (block 610) for processing the first available PDU; in particular, when more than one TCP connections are present in the TCP connection ready list, the iSCSI assistant 309 may pick up one of the ready TCP connections according to a “first-in, first-out” criterion, i.e., it may pick the TCP connection that is on top (or on bottom) of the TCP connection ready list.

Then, the iSCSI assistant 309 firstly checks the state of the TCP connection picked up from the TCP connection ready list (block 615).

If the TCP connection is in the WAIT FOR HEADER state (exit branch Y of decision block 620), this means the data fetched from the corresponding reassembly buffer correspond at least to a complete PDU BHS 430. If this condition is met, three are the possible cases: the PDU under processing does not carry an AHS 445 (case (a)); or the PDU carries an AHS 445, that has already been received in full and is available in the reassembly buffer (case (b)); or the PDU carries an AHS 445, but the complete AHS 445 has not been received yet (case (c)).

In particular, in an embodiment of the present invention, the header extractor 505 normally assumes, at the beginning of its operation, that no AHS is present in the PDU, and waits for having at least a full BHS in the TCP stream reassembly buffer. When at least a full BHS has been reassembled in the reassembly buffer, the header extractor 505 reads the BHS from the reassembly buffer, and checks (by looking at the field 440, in the second data word of the PDU header) if the PDU header also includes an AHS 445. If it results that the AHS 445 is present, the header extractor 505 waits until the whole AHS is received (in the reassembly buffer corresponding to the TCP connection); if the AHS has not yet been fully received, the extracted portion (the BHS) of the PDU header is not placed to the iSCSI header queue 311, being instead kept in wait: in particular, the header extractor 505 does not wait for entire AHS, but returns the TCP connection back to the arbiter 507, and requests the arbiter to return the TCP connection back to the TCP connection ready list when at least the entire AHS is received (the size of the AHS 445 is known once BHS 430 is processed). When eventually the full AHS 445 has been received, the TCP connection is brought back to the TCP connection ready list by the arbiter 507; the header extractor 505 then reads the AHS, and places the whole PDU header (BHS 430 plus AHS 445) into the iSCSI header queue 311.

In greater detail, in the above-mentioned case (a) (exit branch N of decision block 625), the full PDU header has already been received, and it is available in the corresponding reassembly buffer. The (header extractor 505 of the) iSCSI assistant 309 extracts the full iSCSI PDU (BHS) header 405 from the TCP stream picked up from the TCP connection ready list (block 630). For example, referring to FIG. 3, and assuming that the TCP connection picked up from the TCP connection ready list for being processed is the connection 307₁, and assuming also that the first PDU waiting to be processed is the PDU PDU₁₁, the header extractor 505 of the iSCSI assistant 309 extracts the header HDR₁₁. The header extractor 505 puts the extracted header HDR₁₁, into the iSCSI header queue 311 (block 635).

The (header validator 510 of the) iSCSI assistant 309 validates “on the fly” the integrity of the extracted PDU header HDR₁₁. To this end, the header validator 510 calculates on the fly the CRC of the header 405 of the PDU being processed (block 640), and, provided that the iSCSI PDU header CRC is enabled for the TCP connection being processed (decision block 645, exit branch Y) it validates (block 650) the header CRC (looking at the header CRC field 415). The header validator 510 appends the result H-STAT₁₁ of the header validation process to the extracted PDU header HDR₁₁, thereby the PDU header HDR₁₁, together with the corresponding header validation result H-STAT₁₁ appended thereto, are placed in the iSCSI header queue 311 (block 655).

The iSCSI assistant 309 then rises an interrupt (INT, in FIG. 3) to the host CPU 205, for signalling the presence of a PDU header in the iSCSI header queue 311 (block 657); in particular, the interrupt is risen only if the interrupt is enabled; the interrupt may in fact be momentarily disabled, because the host CPU is already serving a previously risen interrupt, corresponding to a previously received PDU.

The PDU managing agent 330 (in consequence to the risen interrupt, or because it was already serving an interrupt previously risen) looks at the iSCSI header queue 311, and processes the PDU header; exploiting the information retrieved from the processed PDU header (that fully describes the incoming PDU), the PDU managing agent 330, if it is ascertained that the PDU also carries data, identifies the proper destination SCSI data buffer 350₁, 350₂, . . . , 350ₙ, and the location within the destination SCSI data buffer wherein the data are to be copied (information such as the ITT, the TTT, the offset and payloaf length may be exploited to this purpose); then, the PDU managing agent 330 posts the identified SCSI data buffer to the iSCSI data queue 313₁, 313₂ and 313₃ that corresponds to the TCP connection. Once the PDU header has been processed, it is removed from the iSCSI header queue (for example, by the PDU managing agent 330).

The iSCSI assistant 309 then updates the state of the TCP connection, and passes the TCP connection back to the arbiter 507, for re-arbitration. In particular, looking at the received PDU header (particularly, the BHS 430), the iSCSI assistant 309 is capable of ascertaining whether the PDU carries a payload, i.e., if the PDU carries data (block 660). In the affirmative case (exit branch Y), the TCP connection state is changed to WAITING FOR DATA (block 661), and the TCP connection is returned to the arbiter 507 (block 663), which decides whether to put the TCP connection back to the TCP connection ready list when (as described in the foregoing) a sufficient amount of data has been received through that TCP connection, and provided that a SCSI data buffer 350₁, 350₂, . . . , 350ₙ has been posted (by the SCSI destination buffer locator 340) to the iSCSI data queue 313₁, 313₂ and 313₃ that corresponds to such TCP connection. If instead the PDU does not carry data (exit branch N of decision block 660), the TCP connection state is changed to WAITING FOR HEADER, and the control is passed back to the arbiter 507; in this way, if the arbiter 507 detects that, on such a TCP connection, a full BHS 430 of the next PDU has been received and is available in the corresponding reassembly buffer, the TCP connection is kept in the TCP connection ready list, and the next PDU can be processed; otherwise, the TCP connection is removed from the TCP connection ready list (and will be re-added to the list when a full BHS 430 will be received).

In case (b) described above (exit branch Y of decision block 625, and connector J1), that is, if the PDU being processed also includes an AHS 445, the iSCSI assistant 309 checks whether the full AHS 445 has already been received and is available in the corresponding reassembly buffer (block 667). In the negative case (exit branch N of decision block 667), the iSCSI assistant 309 removes that TCP connection from the TCP connection ready list (block 670), and asks the arbiter 507 to bring the TCP connection back to the TCP connection ready list when the full AHS 445 will have been received and will be available in the reassembly buffer; the TCP connection remains in the WAIT FOR HEADER state.

If instead the full AHS 445 has already been received (exit branch Y of decision block 667), the iSCSI assistant 309 extracts from the inbound PDU the full iSCSI PDU header 405, puts the extracted header into the iSCSI header queue 311, and, if the header CRC is enabled for that TCP connection and present in the incoming PDU, it validates “on the fly” the integrity of the extracted PDU header (all these actions, similar to those performed in case (a) described above, are summarized by a single block 671). The operation flow continues in a way similar to that described above in connection with case (a), by rising an interrupt (if enabled) to the host CPU 205), for signalling the presence of a PDU header in the iSCSI header queue 311, and checking whether the PDU carries data or not (connector J3, and following blocks 657 to 663).

Back to decision block 620, if the iSCSI assistant 309 detects that the TCP connection picked up from the TCP connection ready list is in the WAITING FOR DATA state (exit branch N of decision block 620, and connector J4), it means that the data fetched from the reassembly buffer is a chunk of the expected PDU payload. The iSCSI assistant 309 calculates on the fly the payload CRC (block 675), and causes the data received over that TCP connection to be moved to the SCSI data buffer posted to the corresponding iSCSI data queue 313₁, 313₂ and 313₃ (block 677).

Then, the iSCSI assistant 309 ascertains whether the most recently received (and processed) chunk of data is the last in the current PDU (the PDU currenly processed) (block 679); in the affirmative case (exit branch Y of decision block 679), the payload CRC is validated (provided that the payload CRC is enabled for that TCP connection), and the validation result is placed into the iSCSI header queue 311 (blocks 681 to 685. Then, the TCP connection state is changed to WAITING FOR HEADER (block 687), and the TCP connection is returned back to the arbiter 507, for re-arbitration (block 689). If instead the lastly received chunk of data is not the last of the current PDU (exit branch N of decision block 679), the TCP connection remains in the WAITING FOR DATA state, and it is returned back to the arbiter, for re-arbitration.

Thus, the iSCSI header queue 311 includes the iSCSI PDU header, and, optionally, information about the PDU header status (i.e., the result of the header CRC validation process, is any), as well as information about the PDU payload status, including the result of the payload CRC validation. This allows a simple synchronization of the processing of the PDU header and data portions, and an efficient implementation of the iSCSI recovery, in case of corruption of the payload. The PDU payload is instead directly copied from the reassembly buffer of the corresponding TCP connection into the proper SCSI destination data buffer, exploiting a DMA mechanism, without the need of any intervention by the host CPU 205, which is thus relieved from a great processing burden.

It is observed that, according to the described embodiment of the present invention, while a number of iSCSI data queues corresponding to the number of TCP connections is provided, a single, unique iSCSI header queue is expediently provided for storing the iSCSI PDU headers of incoming PDUs from all the TCP connections. The provision of a single iSCSI header queue for all the TCP connections allows an efficient implementation in software of an agent, running for example under the control of the host CPU 205 and handling the inbound iSCSI PDUs. In fact, the inbound PDU managing software agent, and thus the host CPU, needs not arbitrating between the different TCP connections, nor managing a multi-tasking handling of the different TCP connections: the handling of different TCP connections is offloaded from the host CPU to the TOE 223.

In particular, the provision of the single, unique iSCSI header queue 311 allows an efficient handling of all the different TCP connections by means of a single software task, run for example by the host CPU 205 (as in the exemplary embodiment herein considered) or, alternatively, by the processor 225 of the periheral implementing the TOE 223, e.g. the NIA 221. The single iSCSI header queue 311 contains all the information needed for handling inbound iSCSI PDUs.

According to an embodiment of the present invention, the iSCSI assistant 309 may rise an interrupt (provided that the interrupt is enabled), to the host CPU 205 whenever a PDU header is put into the iSCSI header queue 311. The host CPU 205 is thus signalled of the presence of new iSCSI PDUs waiting to be processed. In reply to the risen interrupt, the iSCSI PDU header processor 335 processes the available PDU headers in the iSCSI header queue 311, until the queue is emptied; at that time, the interrupt is re-enabled. Such an interrupt notification scheme allows coalescing interrupts between different TCP connections; the number of risen interrupts can thus be reduced to a single interrupt per multiple SCSI requests.

Thanks to the solution described in the foregoing, the processing of inbound iSCSI PDUs by the host CPU is greatly simplified: a significant part of iSCSI PDU processing is in fact performed in hardware, by the TOE, and not by the host CPU; in particular, the host CPU is relieved from the burden of detecting incoming PDUs from different TCP connections, detecting the PDUs' boundaries, validating the data integrity (when required), copying the PDUs' payload to the proper SCSI destination buffers.

The described solution allows implementing an essentially full TCP termination in hardware.

In particular, the host CPU needs not arbitrating between the different TCP connections: the host CPU simply sees a single PDU header queue, wherein the headers of all the incoming iSCSI PDUs can be found, together with information on the PDU header and data integrity. Thus, the host CPU needs not continously serving interrupts whenever a new PDU arrives: the iSCSI assistant rise an interrupt only when there is one header in the header queue.

Although the present invention has been disclosed and described by way of some embodiments, it is apparent to those skilled in the art that several modifications to the described embodiments, as well as other embodiments of the present invention are possible without departing from the scope thereof as defined in the appended claims.

1. A method of offloading, from a host data processing unit (205), iSCSI TCP/IP processing of data streams coming through at least one TCP/IP connection (307₁,307₂,307₃), comprising:
providing a Protocol Data Unit (PDU) header queue (311) adapted to store headers (HDR₁₁, . . . , HDR₃₂) of iSCSI PDUs received through the at least one TCP/IP connection;
monitoring the at least one TCP/IP connection for an incoming iSCSI PDU to be processed;
when at least a iSCSI PDU header is received through the at least one TCP/IP connection, extracting the iSCSI PDU header from the received PDU, and placing the extracted iSCSI PDU header into the PDU header queue;
looking at the PDU header queue for ascertaining the presence of iSCSI PDUs to be processed, and processing the incoming iSCSI PDU based on information in the extracted iSCSU PDU header retrieved from the PDU header queue.

2. The method according to claim 1, in which said looking at the PDU header queue includes causing the host data processing unit to be signalled of the presence of an iSCSI PDU header to be processed in the PDU header queue.

3. The method according to claim 2, in which said causing the host data processing unit be signalled includes rising an interrupt to the host data processing unit, the processing of the iSCSI PDU header in the PDU header queue being under the responsibility of the host data processing unit.

4. The method according to claim 3, further including causing the interrupt to the host data processing unit be disabled after it is risen and until the PDU header queue is emptied.

5. The method according to claims 1 or 2, further comprising:
performing an integrity validation of the extracted iSCSI PDU header, and placing into the PDU header queue information concerning a result of the iSCSI PDU header integrity validation.

6. The method according to claim 5, in which said performing an integrity validation of the extracted iSCSI PDU header comprises ascertaining whether an iSCSI PDU header digest (415) is enabled, and said placing into the PDU header queue information concerning a result of the iSCSI PDU header integrity validation being performed only if the iSCSI PDU header digest is enabled.

7. The method according to claims 1 or 2, further comprising:
providing an iSCSI PDU data queue (313₁,313₂,313₃) for each of the at least one TCP/IP connection, the iSCSI PDU data queue being adapted to store information in respect of destination SCSI data buffers whereinto data (DATA₁₁, . . . , DATA₃₂) carried by the iSCSI PDUs received through the at least one TCP/IP connection are to be copied;
identifying a destination SCSI data buffer (350₁, . . . , 350ₙ) whereinto the data carried by an iSCSI PDU received through the at least one TCP/IP connection are to be copied, said identifying including exploiting information retrieved from the extracted iSCSI PDU header in the PDU header queue;
placing destination SCSI data buffer identification information into the iSCSI PDU data queue associated with the corresponding at least one TCP connection, and
directly copying an iSCSI PDU payload (425), extracted from the received iSCSI PDU, into the identified destination SCSI data buffer, said directly copying using the destination SCSI data buffer identification information placed in the data queue.

8. The method according to claim 7, in which said directly copying includes using a direct memory access (227) to the identified destination SCSI data buffer substantially without intervention of the host data processing unit.

9. The method according to claim 8, in which said directly compying includes copying the iSCSI PDU payload from a reassembly buffer associated with the at least one TCP/IP connection directly into the identified destination SCSI data buffer.

10. The method according to claim 7, 8 or 9, further comprising:
performing an integrity validation of the iSCSI PDU payload, and placing into the header queue information concerning the result of the PDU payload integrity validation.

11. The method according to claim 10, in which said performing an integrity validation of the iSCSI PDU payload comprises ascertaining whether an iSCSI PDU header digest (420) is enabled, and said placing into the PDU header queue information concerning the result of the iSCSI PDU payload integrity validation being performed only if the iSCSI PDU payload digest is enabled.

12. The method according to claim 1 or 2, in which said monitoring the at least one TCP/IP connection comprises:
waiting for a complete iSCSI PDU Basic Header Segment (430) to be received through the at least one TCP/IP connection;
examining the iSCSI PDU Basic Header Segment for ascertaining whether the incoming iSCSI PDU includes an Additional Header Segment (445), and, in the affirmative case, waiting for the full Additional Header Segment to be received before extracting the iSCSI PDU header.

13. The method according to claim 12, in which said monitoring the at least one TCP/IP connection further comprises:
after having extracted the iSCSI PDU header, waiting for at least a portion of iSCSI PDU payload to be received and, before directly copying the received portion of iSCSI PDU payload into a destination SCSI data buffer, waiting for availability of the destination SCSI data buffer.

14. The method according to claim 13, in which said waiting for availability of the destination SCSI data buffer includes waiting for the destination SCSI data buffer identification information to be placed in the data queue associated with the TCP/IP connection.

15. An iSCSI TCP/IP offload engine for offloading, from a host data processing unit (205), iSCSI TCP/IP processing of data streams coming through at least one TCP/IP connection (307₁,307₂,307₃), the offload engine comprising:
an incoming iSCSI PDU monitor (507) adapted to monitor incoming PDUs from at least one TCP/IP connection (307₁,307₂,307₃);
a PDU header queue (311) common for all the TCP/IP connections;
a PDU header extractor (505) adapted to extract a PDU header (HDR₁₁, . . . , HDR₃₂) from an incoming PDU, placing the extracted header into the header queue, and managing a signalling (INT) of the presence in the PDU header queue of a PDU header to be processed to a PDU header processor (335).

16. The iSCSI TCP/IP offload engine according to claim 15, in which the PDU header processor runs under responsibility of the host data processing unit, the PDU header extractor being adapted to signalling the host data processing unit of the presence in the PDU header queue of a PDU header to be processed.

17. The iSCSI TCP/IP offload engine according to claim 16, in which the PDU header extractor is adapted to manage the rising of interrupt of the host data processing unit.

18. The iSCSI TCP/IP offload engine according to claim 15, in which the PDU header processor runs under responsibility of the offload engine.

19. The iSCSI TCP/IP offload engine according to claims 15 or 16, further comprising:
a header validator (510) adapted to perform an integrity validation of the extracted PDU header, and to place into the PDU header queue information concerning a result of the PDU header integrity validation.

20. The iSCSI TCP/IP offload engine according to claim 19, further comprising:
a PDU data queue (313₁,313₂,313₃) for each of the at least one TCP connection, the PDU data queue being adapted to store information in respect of destination SCSI data buffers whereinto data (DATA₁₁, . . . , DATA₃₂) of the iSCSI PDUs received through the at least one TCP/IP connection are to be copied; and
a PDU payload mover (520) for managing the extraction of a PDU payload from the incoming PDU and the copying thereof into a proper destination SCSI data buffer (350₁, . . . , 350ₙ), based on information retrieved from the data queue.

21. The iSCSI TCP/IP offload engine according to claim 20, in which the PDU payload mover is adapted to cause a direct copying of the extracted PDU payload into the proper destination SCSI data buffer using a direct memory access engine.

22. The iSCSI TCP/IP offload engine according to claims 20 or 21, further comprising:
a payload validator (515) adapted to perform an integrity validation of the extracted PDU payload, and to place into the PDU header queue information concerning a result of the PDU payload integrity validation.

23. The iSCSI TCP/IP offload engine according to claim 15, in which the monitor includes an arbiter adapted to manage a TCP/IP connection ready list.

24. The iSCSI TCP/IP offload engine according to claim 23, in which the arbiter is adapted to put a TCP/IP connection in the TCP/IP connection ready list on condition that sufficient, predetermined amount of data has been received through that TCP connection.

25. A method of offloading, from a host data processing unit (205), iSCSI TCP/IP processing of data streams coming through at least one TCP/IP connection (307₁,307₂,307₃), comprising:
providing a Protocol Data Unit (PDU) header queue (311) adapted to store headers (HDR₁₁, . . . , HDR₃₂) of iSCSI PDUs received through the at least one TCP/IP connection;
monitoring the at least one TCP/IP connection for an incoming iSCSI PDU to be processed;
when at least a iSCSI PDU header is received through the at least one TCP/IP connection, extracting the iSCSI PDU header from the received PDU, and placing the extracted iSCSI PDU header into the PDU header queue.

26. A network interface adapter card for connecting devices to a communications network includes physical-level interface devices for managing physical details of communication through said communications network;
media access control (MAC) layer for controlling access to the communications network; and
TCP/IP offload engine intercepting packets from at least one TCP/IP connection and processing portions of said packets relating only to TCP/IP protocol.

27. The NIA card of claim 26 wherein the TCP/IP offload engine includes:
a PDU data queue (313₁,313₂,313₃) for each of the at least one TCP connection, the PDU data queue being adapted to store information in respect of destination SCSI data buffers whereinto data (DATA₁₁, . . . , DATA₃₂) of the iSCSI PDUs received through the at least one TCP/IP connection are to be copied; and
a PDU payload mover (520) for managing the extraction of a PDU payload from the incoming PDU and the copying thereof into a proper destination SCSI data buffer (350₁, . . . , 350ₙ), based on information retrieved from the data queue.
